(19) United States
(12) Patent Application Publication
(10) Pub. No.: US 2017/0107925 A1
(43) Pub. Date: Apr. 20, 2017

(54) Vehicle Idle Shutdown System

(71) Applicant: TAS Distributing Company, Inc., Peoria, IL (US)

(72) Inventor: Loran Sutton, East Peoria, IL (US)

(21) Appl. No.: 14/887,015

(22) Filed: Oct. 19, 2015

(51) Int. Cl. F02D 41/04

(52) U.S. Cl. CPC F02D 41/042

(57) ABSTRACT

A system and method for executing an automatic engine shutdown in an idling vehicle is described. The method includes determining an engine running condition for a vehicle, confirming the vehicle speed is zero for the entirety of a first length of time, confirming the vehicle driver seat is unoccupied for the entirety of the same first length of time, setting an engine shutdown time, beginning a countdown to the engine shutdown time, and then shutting down the vehicle engine, including battery-powered accessories, when the countdown reaches the shutdown time. The system includes a processor having a plurality of signal inputs ports, an engine idle sensor, a speed sensor, a driver seat sensor, a timing mechanism, and a controller configured to shutdown the engine and battery-operated accessories when the timing mechanism completes a countdown of a shutdown time.

### TECHNICAL FIELD OF THE INVENTION

The present invention relates to a system and methods for conserving gas, lowering emissions, reducing engine wear and improving safety in vehicles. Specifically, the invention relates to an engine system and method for automatically shutting down vehicles after a predetermined idle time.

### BACKGROUND OF THE INVENTION

According to an annual study by IHS Automotive, there were a record 253 million cars and truck on U.S. roads in 2014. The same study estimates that the average vehicle age in 2014 was about 11.4 years old. Expectations are that both those numbers will be steadily increasing going into 2020.

Despite increasing costs for gasoline (or crude oil products, in general), the growing concern about the environment, and the higher demand for improved vehicle safety, people appear to be buying more vehicles and keeping them longer. In order to keep vehicles longer, better care must be taken, especially to the engine. However, aside from regular oil changes and other preventative maintenance, the one practice that can add service time to a vehicle engine is to prevent prolonged idling, i.e., over 15 minutes. While tires and the vehicle drive train suffer no ill-effects during idling, the engine experiences wear and stresses not completely unlike driving, but without registering odometer mileage. For this reason, it is wise to minimize idling time in all combustion engines.

Further, from environmental and safety standpoints, idling adds carbon monoxide gases without the benefit of actually providing transportation to people or cargo, the primary purpose of most vehicles on the road. If confined to a closed area, such as a garage, this can lead to accidental death from carbon monoxide poisoning.

Not all such idling is intentional. For example, in cars that have keyless, push-button ignition, an electronic key fob is recognized by the car to authorize driving and the use of power accessories. That fob can conveniently remain in the driver's pocket or purse, as the ignition switch itself is just a button on the dash. Therefore, it is possible for the driver to leave the vehicle with the key fob and the engine will remain idling. News reports have linked carbon monoxide deaths to keyless ignitions.

Until the invention of the present application, these and other problems in the prior art went either unnoticed or unsolved by those skilled in the art. The present invention provides unique, simple and economical methods and systems for conserving gas, lowering emissions, reducing engine wear and improving safety in vehicles without sacrificing vehicle affordability, durability or aesthetics.

### SUMMARY OF THE INVENTION

There is disclosed herein a system and a method for automatically shutting down a vehicle engine which overcome disadvantage of prior systems and methods while affording additional operating advantages.

Generally speaking, a method for executing an automatic engine shutdown in an idling vehicle comprises the steps of determining an engine running condition for a vehicle, confirming the vehicle speed is zero for the entirety of a first length of time, confirming the vehicle driver seat is unoccupied for the entirety of the same first length of time, setting an engine shutdown time, beginning a countdown to the engine shutdown time, and then shutting down the vehicle engine, including battery-powered accessories, when the countdown reaches the shutdown time.

In an embodiment, the method may further include the step of interrupting the countdown when either of the steps of confirming the vehicle speed is zero or confirming the vehicle driver seat is unoccupied changes during the length of time. Preferably, the first length of time is in the range of from about 5 to about 30 minutes.

In an embodiment, the method may further include the step of signaling imminent engine shutdown before shutting down the vehicle engine. Such a signal may be visual, audible, or both.

The present description is also directed to an automatic engine shutdown system. Generally speaking, the system comprises a processor having a plurality of signal inputs ports and positioned on a vehicle having an engine, an engine idle sensor electronically coupled to the processor via a signal input port, a speed sensor electronically coupled to the processor via a signal input port, a driver seat sensor electronically coupled to the processor via a signal input port, a timing mechanism coupled to the processor and configured to countdown a predetermined time when the processor receives a proper signal from the engine idle sensor, the speed sensor and the driver seat sensor, and a controller electronically coupled to the timing mechanism and the vehicle engine and configured to shutdown the engine and battery-operated accessories when the timing mechanism completes the countdown of the predetermined time.

In an embodiment, the automatic engine shutdown system may include an override switch for preventing engine shutdown.

These and other aspects of the invention may be understood more readily from the following detailed description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a schematic illustrating an embodiment of the engine shutdown system; and

FIG. 2 is a flow diagram illustrating a method of the engine shutdown system.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

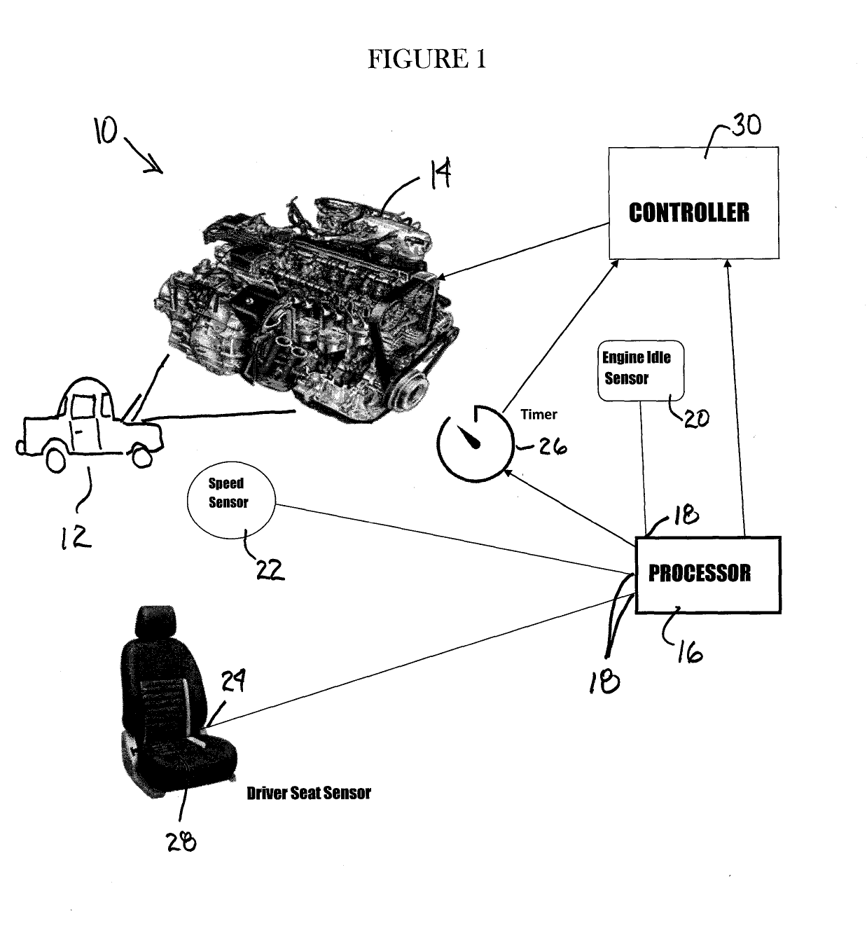

With reference to the schematic of FIG. 1, an embodiment of an automatic engine shutdown system, generally referenced with the numeral 10, is illustrated. The system 10 is installed on a vehicle 12 either as an OEM feature or as a retrofit system. The system 10 operates by any of the numerous embodiments of the method described below to shut down a vehicle engine 14, including any battery-operated accessories (e.g., radio). Generally speaking, the system 10 comprises a processor 16 having a plurality of signal input ports 18, an engine idle sensor 20 electronically coupled to the processor 16 via a signal input port, a speed sensor 22 electronically coupled to the processor 16 via a signal input port, a driver seat sensor 24 electronically coupled to the processor 16 via a signal input port, a timing mechanism 26 coupled to the processor 16 and a controller 30 electronically coupled to the timing mechanism 26 and the vehicle engine 14.

The processor 16 is tasked with registering signal inputs from each of the disclosed sensors to determine a status for each. The engine idle sensor 20 sends a signal to the processor 16 regarding engine operation. The speed sensor 22 sends a signal to the processor 16 regarding vehicle speed. And, the driver seat sensor 24, which may include a seatbelt buckle sensor, for example, sends a signal to the processor 16 regarding the occupancy status of the driver seat 28.

Also coupled to the processor 16 is a timing mechanism 26. The timing mechanism 26 accepts electronic instructions from the processor 16 to begin countdown of a time, T, when the processor 16 receives the proper signals from the engine idle sensor 20, the speed sensor 22 and the driver seat sensor 24. The countdown time can be a predetermined duration programmed into the timing mechanism 26, or the processor 16 can instruct the timing mechanism 26 on the duration based on predetermined factors.

Finally, the controller 30 is configured to shutdown the engine 14 and all battery-operated accessories when the timing mechanism 26 completes the countdown of the predetermined time. This shutdown can be affected in any number of ways, but preferably works by cutting battery power to the engine.

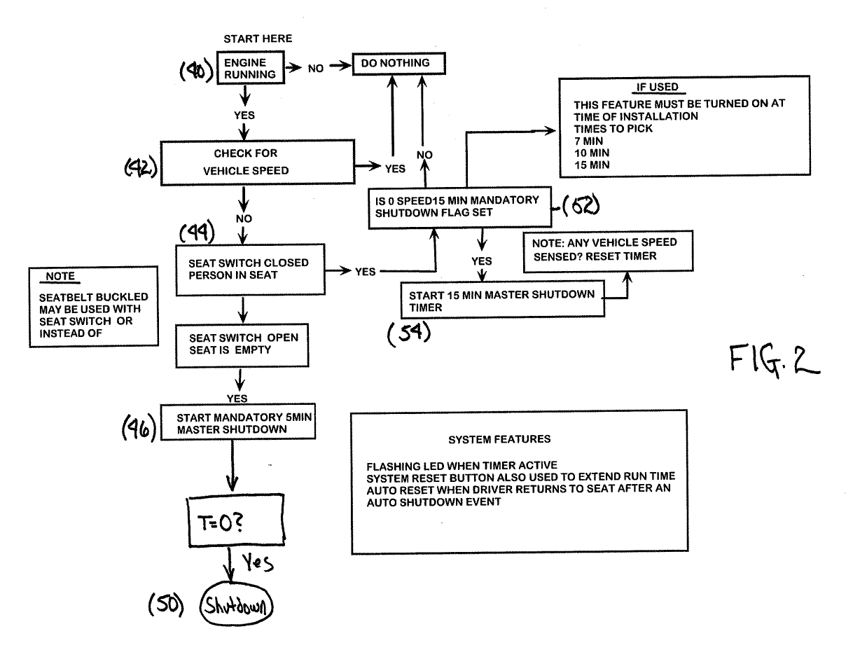

Referring now to FIG. 2, there is illustrated a flowchart illustrating a preferred operating method for an embodiment of the disclosed automatic engine shut-down system 10. Generally speaking, the method is used to shutdown an idling vehicle by verifying the existence of three conditions. The conditions include sensing that the vehicle engine is running (40), confirming that vehicle speed is zero (42)—i.e., the vehicle is not moving—then, confirming that the vehicle does not have a driver (44). Once these three conditions are positively met, an engine shutdown time is automatically set and a countdown to the engine shutdown time is commenced (46). If the three conditions remain for the entirety of the countdown, then the vehicle engine and all battery-powered accessories are shutdown when countdown reaches the shutdown time (50).

However, if a vehicle speed is sensed, then the countdown will terminate and the shutdown time will be reset (52). Likewise, the sensing of occupancy of the driver's seat can also terminate the countdown. Alternatively, the countdown may continue with driver occupancy, but an override switch may be provided to allow manual termination of the countdown. As an option, a mandatory shutdown time can be set regardless of the driver seat occupancy (54). This feature addresses concerns regarding a sleeping driver, for example.

Preferably, the countdown should be visibly displayed within the vehicle, using one of either a digital or analog timer. The countdown is preferably in the range of from about 5 minutes to about 30 minutes, with about 15 minutes being the most preferred time. However, many different operating conditions known to those skilled in the art can dictate longer or shorter idling periods before engine shutdown. Further, an audible signal (e.g., a beep) and/or visual signal (e.g., a red light) can be triggered a short period (e.g., 10 seconds) before shutdown.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A method for executing an automatic engine shutdown in an idling vehicle comprising the steps of:
determining an engine running condition for a vehicle;
confirming vehicle speed is zero for entirety of a first length of time, T;
confirming a vehicle driver seat is unoccupied for entirety of the first length of time, T;
setting an engine shutdown time;
beginning a countdown to the engine shutdown time; and
shutting down the vehicle engine and battery-powered accessories when countdown reaches the shutdown time.

2. The method of claim 1, further comprising the step of interrupting the countdown when either of the steps of confirming vehicle speed is zero or confirming vehicle driver seat is unoccupied changes during the length of time, T.

3. The method of claim 1, wherein the first length of time is in the range of from about 5 to about 30 mins.

4. The method of claim 3, wherein the first length of time is about 15 mins.

5. The method of claim 1, further comprising the step of signaling imminent engine shutdown before shutting down the vehicle engine.

6. The method of claim 5, wherein the step of signaling is visual.

7. The method of claim 5, wherein the step of signaling is audible.

8. The method of claim 1, wherein the engine shutdown time is set to occur within the first length of time, T.

9. The method of claim 1, wherein the step of confirming a driver seat is unoccupied comprises the step of sensing an unbuckled driver side seat belt.

10. An automatic engine shutdown system comprising:
a processor having a plurality of signal inputs ports and positioned on a vehicle having an engine;
an engine idle sensor electronically coupled to the processor via a signal input port;
a speed sensor electronically coupled to the processor via a signal input port;
a driver seat sensor electronically coupled to the processor via a signal input port;
a timing mechanism coupled to the processor and configured to countdown a predetermined time, T when the processor receives a proper signal from the engine idle sensor, the speed sensor and the driver seat sensor; and
a controller electronically coupled to the timing mechanism and the vehicle engine and configured to shutdown the engine and battery-operated accessories when the timing mechanism completes the countdown of the predetermined time.

11. The automatic engine shutdown system of claim 10, further comprising an override switch for preventing engine shutdown.

12. The automatic engine shutdown system of claim 10, further comprising a signal electronically coupled to the timing mechanism to indicate a status of the countdown of the predetermined time.

13. The automatic engine shutdown system of claim 12, wherein the signal is visual.

14. The automatic engine shutdown system of claim 12, wherein the signal is audible.

15. The automatic engine shutdown system of claim 10, wherein the driver seat sensor is coupled to a driver side seat belt.
